(19) United States
(12) Patent Application Publication
(10) Pub. No.: US 2015/0179362 A1
(43) Pub. Date: Jun. 25, 2015

(54) LOAD-TRANSFER SWITCH, ON-LOAD TAP CHANGER, AND METHOD OF SWITCHING SAME

(71) Applicant: Maschinenfabrik Reinhausen GmbH, Regensburg (DE)

(72) Inventors: Christian Hammer, Regensburg (DE); Andreas Sachsenhauser, Mallersdorf-Pfaffenberg (DE)

(21) Appl. No.: 14/417,267

(22) PCT Filed: Jul. 11, 2013
(86) PCT No.: PCT/EP2013/064668

§ 371 Date: Jan. 26, 2015

(30) Foreign Application Priority Data
Aug. 14, 2012 (DE) 10 2012 107 446.1

(51) Int. Cl. H01H 9/00

(52) U.S. Cl. CPC H01H 9/0016; H01H 9/0027

(57) ABSTRACT

The invention relates to a load transfer switch for an on-load tap changer for switching from a connected winding tap to a preselected winding tap of a tapped transformer. The load transfer switch comprises at least one resistance-free current path and at least one resistive path. A measuring device measures an actual value of a phase angle between a load current and a tapped transformer voltage from the preselected winding tap for discharging a current. The chronological connection sequence of the paths of the load transfer switch can be variably adjusted by an adjusting device dependent on the measured actual value and a specified threshold of the phase angle such that the voltage constantly lies within a voltage range between the connected winding tap and the preselected winding tap during a load switch. The invention also relates to an on-load tap changer with such a load transfer switch and to a method for switching a load transfer switch from a connected winding tap to a preselected winding tap of a tapped transformer.

The present invention relates to a load changeover switch, an on-load tap changer with the load changeover switch according to the invention and a method of switching over a load changeover switch of an on-load tap changer from a connected winding tap of a tapped transformer to a preselected winding tap of the tapped transformer.

On-load tap changers (known as such in English and abbreviated as OLTC) are known from the prior art. They serve for uninterrupted switching over between different winding taps of tapped transformers. On-load tap changers comprise a load changeover switch and a selector, consisting of a fine selector and possibly a preselector. The selector serves for power-free selection of the respective new winding tap of a tapped transformer to be switched over to. The load changeover switch serves for subsequent rapid and uninterrupted switching over from the previously connected winding tap to the new, preselected winding tap that is to be connected.

During the load changeover process the load changeover switch executes a specific switching sequence (switching course) in which different switches in resistance paths, so-called resistance switches, and switches in resistance-free paths (current paths) are actuated in a specific time sequence in succession or in overlapping manner. The switches in that case serve for direct connection of the respective winding tap with the load diverter or current take-off in an energy supply mains, hereinafter called mains for short. The resistance contacts serve for temporary connection by means of one or more switch-over resistances.

During the changeover process, load changeover switches generate voltage fluctuations, also called ‘flicker’, in the mains. Voltage fluctuations in electrical energy supply mains lead to, for example, changes in the emitted light density of lighting means, such as, for example, bulbs. If a specific level is exceeded, such light density changes are perceived by people as disturbing. The flicker effect increases with the frequency and with the level of the voltage changes. In order to ensure voltage quality in mains, there are limit values for maximum flicker (flicker limit values).

Due to the increase in decentral energy suppliers such as, for example, photovoltaic plants it will also be necessary in the future to equip transformers in local energy supply mains with on-load tap changers. In the case of sunny weather without clouds a comparatively large amount of current is fed almost constantly into the mains. In the case of clouds without or with hardly any sun a comparatively small amount of current is supplied almost constantly to the mains. Thereagainst, in the case of sunny weather with changing levels of cloud small and large amounts of current are supplied in alternation at comparatively short intervals in time. For transformers of such local energy supply mains the load current (load flux) can therefore frequently change in dependence on the instantaneous supply situation, so that there is a risk of undesirably high levels of flicker.

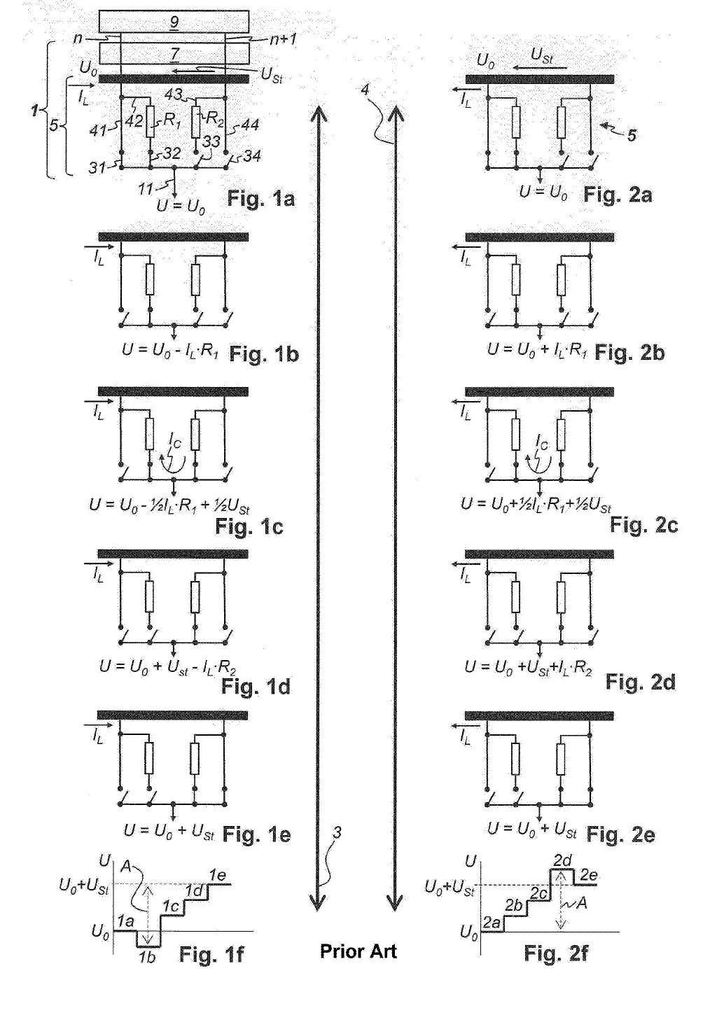

In the case of previously known on-load tap changers with two switch-over resistances, for example OILTAP (Registered Trade Mark) M and VACUTAP (Registered Trade Mark) VM, and in the case of known on-load tap changers with one switch-over resistance, for example VACUTAP (Registered Trade Mark) VR, undesirably high flicker levels arise during the load changeover depending on the respective load flow direction for the transformer and depending on the direction of switching (see following description with respect to FIGS. 1 to 6).

It is therefore the object of the invention to create a load changeover switch that regardless of the direction of the load current in the switching direction, thus the switching on and switching off of voltage steps, always generates a minimum flicker level. This object is fulfilled by a load changeover switch according to claim 1.

The object of the invention is additionally to create a load changeover switch that always produces a minimum flicker level regardless of the direction of the load current and the switching direction. This object is fulfilled by a load changeover switch according to claim 7.

Moreover, the object of the invention is to create a method of switching over a load changeover switch of an on-load tap changer from one connected winding tap of a tapped transformer to a preselected winding tap of the tapped transformer in which a minimum flicker level is always produced regardless of the direction of the load current and the switching direction. This object is fulfilled by a method of switching over a load changeover switch of an on-load tap changer according to claim 8.

The load changeover switch according to the invention for an on-load tap changer for switching over a connected winding tap to a preselected winding tap of a tapped transformer comprises at least one resistance-free path (current path), at least one path with at least one respective switch-over resistance (resistance path) and a current take-off for conducting a load current that flows between the tapped transformer and the current take-off of the load changeover switch. During operation of the transformer a step voltage is usually present between the winding taps between which switching over shall take place. According to the invention, a measuring device for measuring an actual value of a phase angle between the load current and a voltage of the tapped transformer, in each instance with respect to the direction from the preselected winding tap to the current take-off (load diverter), and an adjuster are additionally provided. Through the adjuster the time sequence of the connection of the paths (current path and resistance path) or the switching paths of the load changeover switch are variably settable in dependence on the measured actual value of the phase angle and a preset limit value of the phase angle in such a manner that during a load changeover the output voltage of the tapped transformer always lies within a voltage interval between the connected and the preselected winding tap. The flicker is proportional to the level of a voltage change. Through use of the load changeover switch according to the invention a lower flicker effect than in the case of tap changers according to the prior art arises, in which the output voltage of the tapped transformer during a load changeover does not always lie within the voltage interval between connected and preselected winding tap, whereby a greater degree of dynamic voltage change arises. A further advantage of the invention is that due to lower flicker levels in the mains higher switching frequencies or higher switching rates are possible without exceeding a predetermined flicker limit value.

In one form of embodiment of the invention at least one switch of the current paths and/or of the resistance paths is adjustable by the adjuster in such a manner that during a load changeover the output voltage of the tapped transformer always lies within the voltage interval between connected and preselected winding tap.

The adjuster can, for example, be operated electrically, electromechanically or magnetically. In particular, the adjuster can be a stroke device. The adjuster can comprise a plurality of adjusting elements, for example a first set of cam discs and a second set of cam discs, by which the paths or switching paths are variably connectable in the sense of the invention. It will be obvious to an expert that instead of the first and/or second cam discs use can also be made of other and/or further means. In particular, the second cam discs can be set by way of a stroke device.

As preset limit value of the phase angle usually 90° can be selected.

In order to be able to determine the phase angle according to known calculation methods the measuring device usually comprises measuring elements for measuring the voltage and the current in the on-load tap changer. In a first form of embodiment two voltage sensors and one current sensor are provided. In that case, the voltage between the connected winding tap and the current take-off can be measured by a first voltage sensor. The voltage between the preselected winding tap and the current take-off can be measured by a second voltage sensor. The current in the current take-off can be measured by the current sensor. In a second form of embodiment one voltage sensor and two current sensors are provided. In that case, the voltage between the connected winding tap and the preselected winding tap can be measured by the voltage sensor. The current from the connected winding tap to the current take-off can be measured by a first current sensor. The current from the preselected winding tap to the current take-off can be measured by a second current sensor.

In a further form of embodiment of the load changeover switch the resistance paths comprise exactly one common switch-over resistance, and/or the resistance paths comprise, in the direction of the current take-off, a respective switch-over resistance upstream of the combining of the resistance paths. Thus, in the second case a respective switch-over resistance is provided on different paths. It will be obvious to an expert that in both cases also a plurality of resistances connected in series can be installed per path of the respective resistance.

The on-load tap changer according to the invention comprises at least one load changeover switch according to the invention as described above as well as a selector for selection of a respective winding tap of the tapped transformer.

The method according to the invention for switching over a load changeover switch of an on-load tap changer from a connected winding tap of a tapped transformer to a preselected winding tap of the tapped transformer comprises a number of steps that are described in the following:

Initially, a limit value of the phase angle between the load current and the voltage of the tapped transformer from the preselected winding tap to the diverter is predetermined on each occasion with respect to the direction from the winding tap to the current take-off or diverter. Subsequently, an actual value of the phase angle is measured. A predetermined time sequence in the connection of current paths and/or resistance paths of the load changeover switch is then selected in dependence on whether the actual value of the phase angle is greater or smaller than the amount of the limit value of the phase angle. According to the invention the connecting or adjusting is carried out in such a manner that during a load changeover the output voltage of the tapped transformer always lies within the above-described voltage interval between connected and preselected winding taps. For this purpose the switches are respectively opened and/or closed as appropriate. A narrow voltage interval moreover advantageously ensures a low flicker level, as already described above.

According to a preferred form of embodiment of the method the switches are connected in a different time sequence, as described in the following, in dependence on the amount of a measured actual value of the phase angle. If the measured actual value of the phase angle is in terms of amount less than the preset limit value of the phase angle (case 1), initially the switch in the resistance path on the side to be switched on closes. Only subsequently does the switch of the resistance-free current path on the side to be switched off open. If, thereagainst, the measured actual value of the phase angle is greater in terms of amount than the predetermined limit value of the phase angle (case 2), initially the switch of the resistance-free current path on the side to be switched on closes. Only subsequently does the switch in the resistance path on the side to be switched off open.

The respective paths or switching paths are thus activatable in situation-dependent manner depending on the direction of the load current and whether voltage steps are switched on or switched off. An appropriate control for controlling the adjuster is therefore similarly provided. The adjuster is coupled with the measuring device. Depending on the results of the measurement device the switching sequence of the load changeover switch, i.e. the connecting (opening or closing) of the switches, is so selectable from two switching sequences by the adjuster activated by the control that a minimum flicker level is always achievable.

In recent years, as is known, vacuum interrupters have preferentially been used as switching elements for load switching over. Advantageously, vacuum interrupters prevent formation of arcs in the oil and thus oil contamination of the load changeover switch oil, as described in, for example, German Patent Specifications DE 195 10 809 [U.S. Pat. No. 5,834,717] and DE 40 11 019 [U.S. Pat. No. 5,107,200] as well as German published specifications DE 42 31 353 and DE 10 2007 004 530. However, the general principle according to the invention, as described above, is suitable for different kinds of on-load tap changers, particularly not only for mechanical changers, for example oil changers, but also for on-load tap changers with vacuum interrupters.

The invention and the advantages thereof are described in more detail in the following with reference to the accompanying drawings, in which:

FIGS. 1a to 1e show a switching sequence for an on-load tap changer according to the prior art with two switch-over resistances, wherein load current and step voltage in the transformer winding are in opposite phase;

FIG. 1f shows a diagram of the voltage steps of the output voltage of the tapped transformer for the on-load tap changer according to FIGS. 1a to 1e;

FIGS. 2a to 2e show a switching sequence for the on-load tap changer according to FIGS. 1a to 1e, wherein load current and step voltage in the transformer winding are in-phase;

FIG. 2f shows a diagram of the voltage steps of the output voltage of the tapped transformer for the on-load tap changer according to FIGS. 2a to 2e;

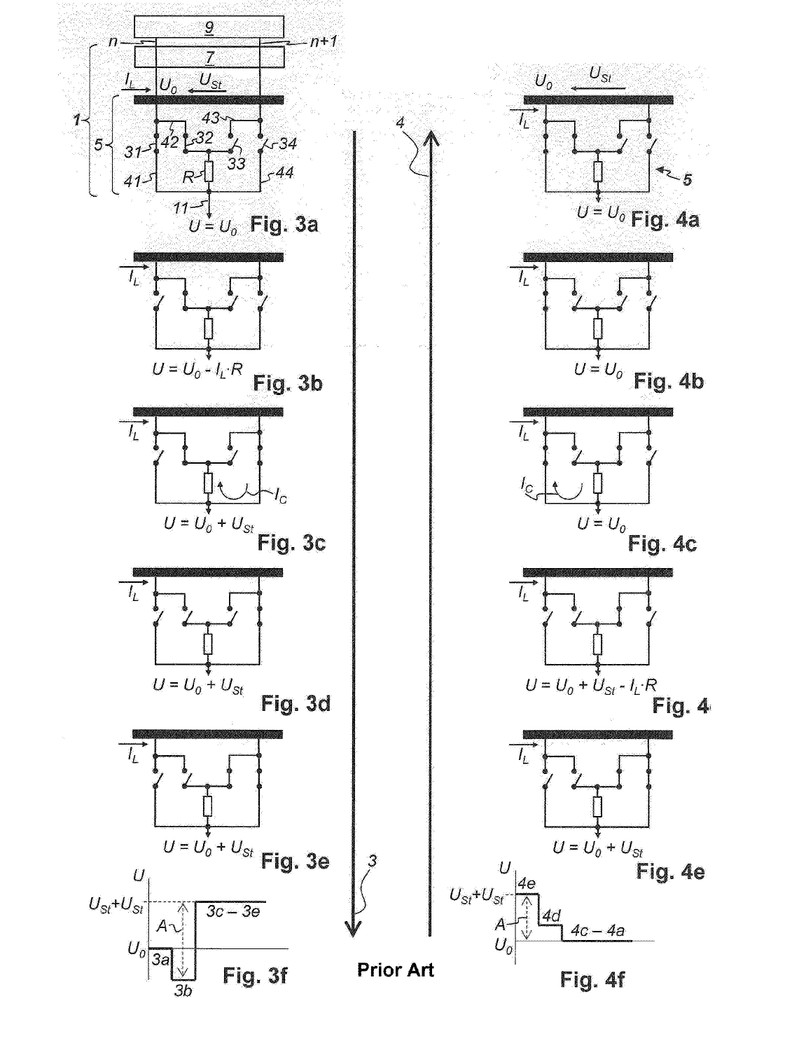

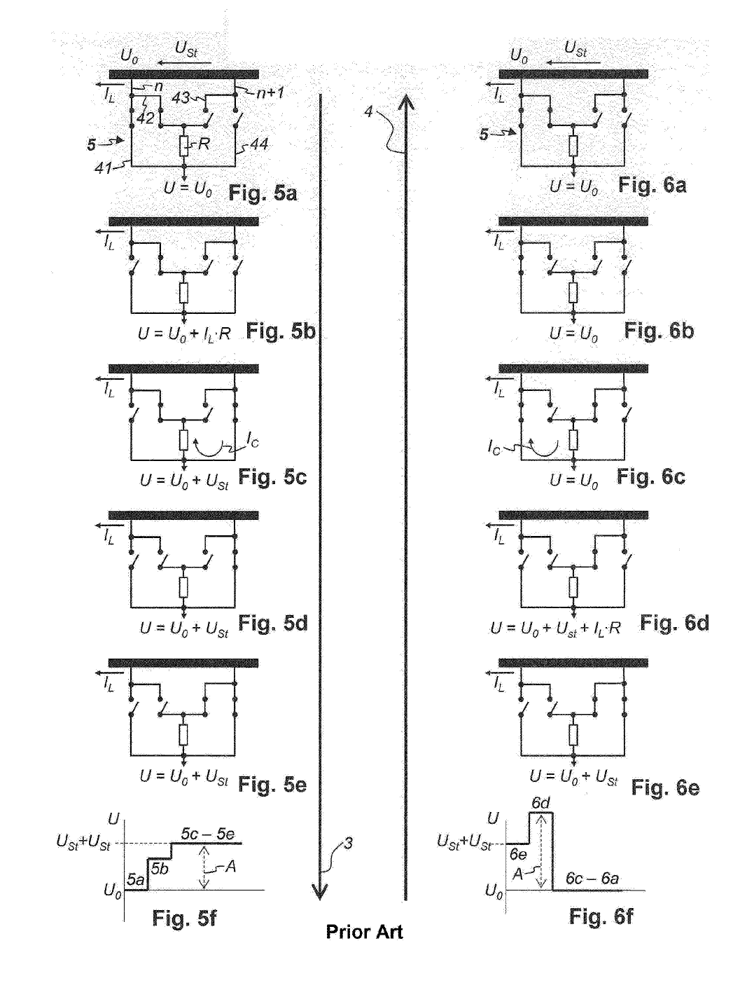

FIGS. 3 to 6 each show a respective switching sequence or respective diagram of the voltage steps of the output voltage of the tapped transformer for a different on-load tap changer according to the prior art with a switch-over resistance, wherein load current and voltage in the transformer winding are in opposite phase in FIGS. 3 and 4 and in-phase in FIGS. 5 and 6;

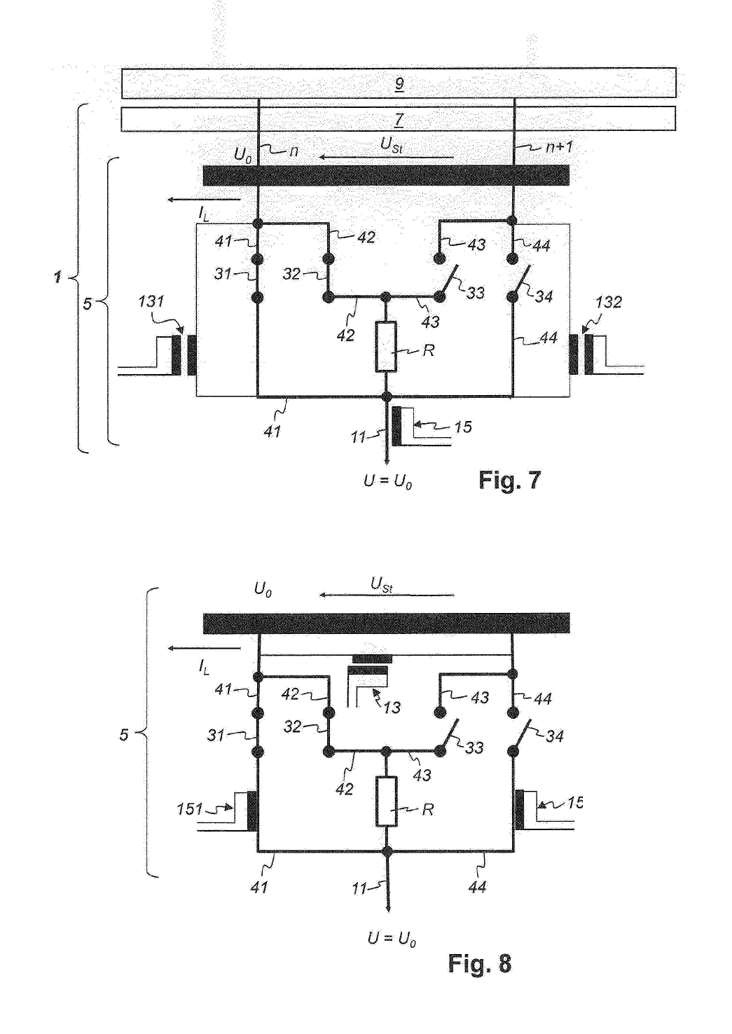

FIG. 7 shows a form of embodiment of the on-load tap changer according to the invention with two voltage sensors and one current sensor, wherein the on-load tap changer comprises a separate load changeover switch and a selector;

FIG. 8 shows another form of embodiment of the on-load tap changer according to the invention for the voltage sensor and two current sensors;

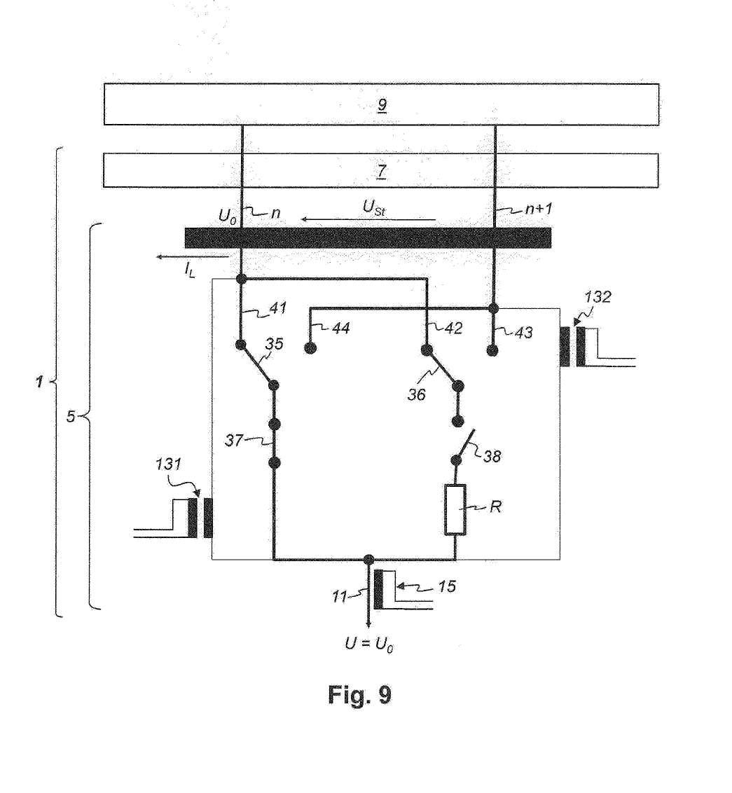

FIG. 9 shows the on-load tap changer in accordance with the invention according to FIG. 7, wherein in each instance the two switches of the current path or the two resistance switches are replaced by a changeover switch in series with an off-switch;

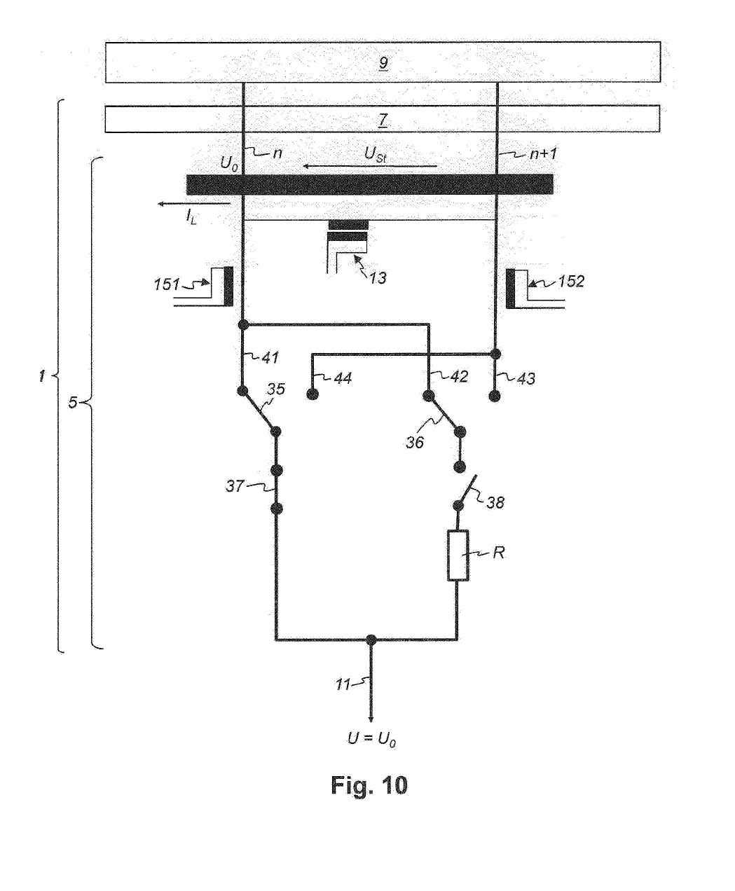

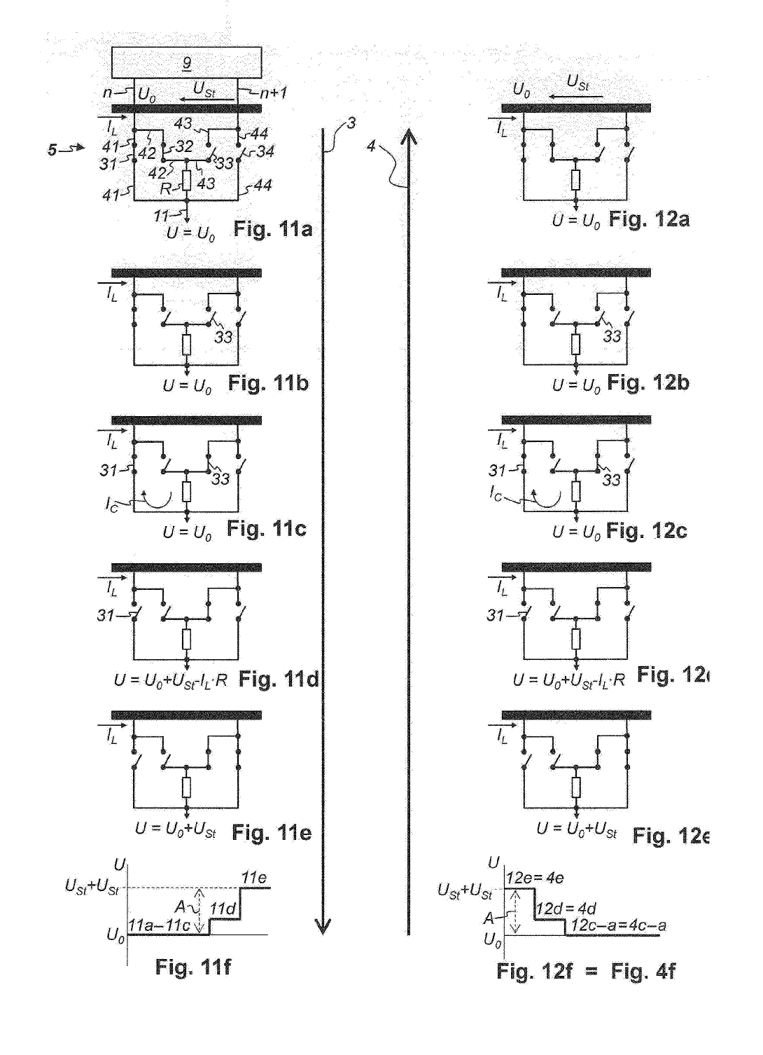

FIG. 10 shows the on-load tap changer according to the invention in accordance with FIG. 8, wherein in each instance the two switches of the current path or the two resistance switches are replaced by a changeover switch in series with an off-switch;

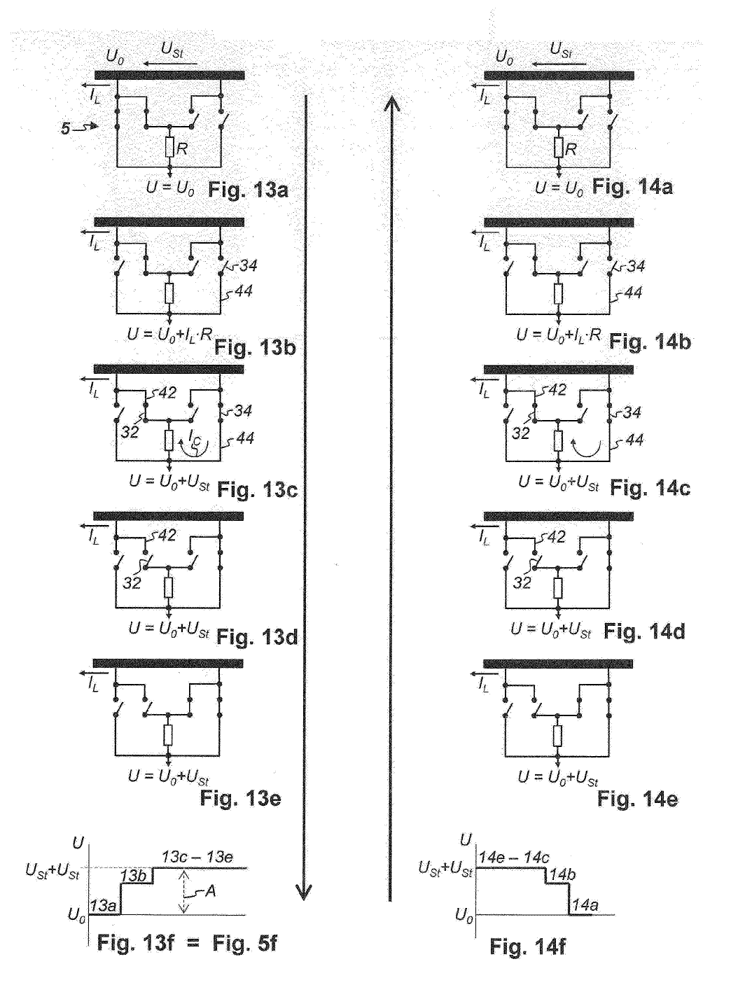

FIGS. 11 to 14 each show a respective switching sequence or respective diagram of the voltage steps of the output voltage of the tapped transformer for the forms of embodiment of the on-load tap changer in accordance with the invention according to FIGS. 7 to 10 with a switch-over resistance;

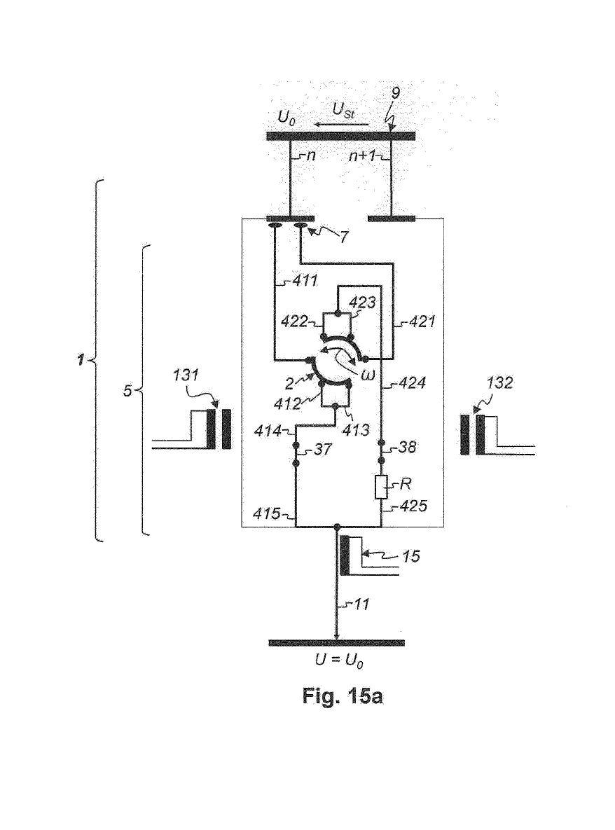

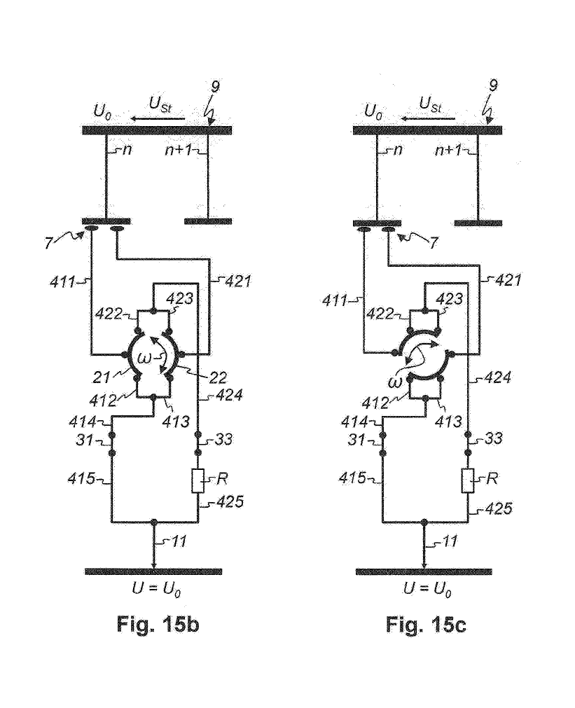

FIGS. 15a to 15c show circuits for another form of embodiment of the on-load tap changer according to the invention with a combined load changeover switch and selector; and

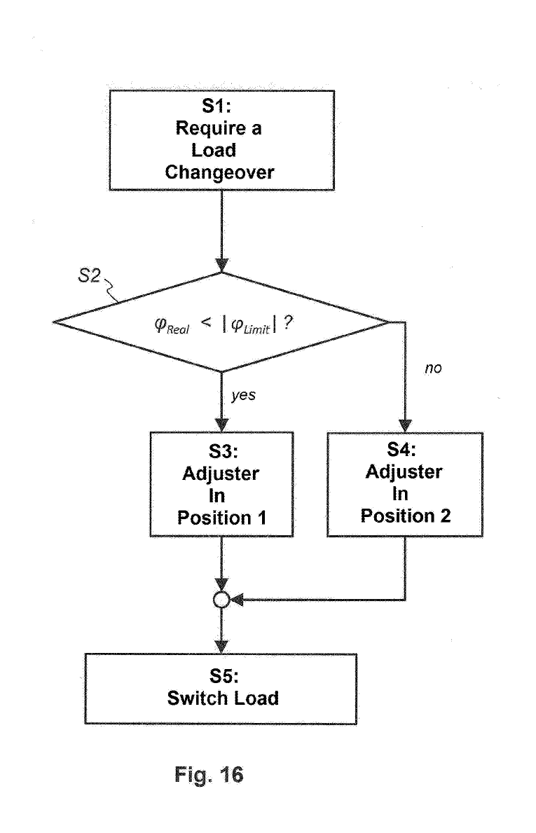

FIG. 16 shows a schematic flow chart of the method according to the invention.

Identical reference numerals are used in the FIGS. for the same or equivalent elements of the invention. Moreover, the sake of clarity only reference numerals necessary for description of the respective FIG. are illustrated in the individual figures.

FIGS. 1a to 1e show a schematic switching sequence for an on-load tap changer 1 according to the prior art, wherein the load current I_{L} and the step voltage U_{St} in the transformer winding are in opposite phase. The sequence 1a to 1e illustrates the switching on of a winding part (from n to n+1) and is represented by the lower arrowhead of the arrow 3. The sequence 1e to 1a illustrates switching back of a winding part (from n+1 to n) and is represented by the upper arrowhead of the arrow 3.

The illustrated on-load tap changer 1 comprises a selector 7 and a load changeover switch 5 that is switchable in five steps. The illustrated load changeover switch 5 comprises two resistance-free switching paths or current paths 41, 44, each with a switch 31, 34 as well as two switching paths or resistance paths 42, 43 each with a switch-over resistance R₁, R₂ and switch 32, 33.

The selector 7 serves for selection of a respective winding tap n, n+1 of a tapped transformer 9 that similarly is illustrated only very schematically in FIG. 1a. In the illustrated switching sequence according to FIGS. 1a to 1e the load changeover switch 5 effects switching over from the initially connected winding tap n according to FIG. 1a to the preselected winding tap n+1 according to FIG. 1e by connection or actuation of the switches 31, 32, 33, 34 in succession in time. The step voltage U_{St} in FIGS. 1a-e lies between the winding taps n and n+1.

In accordance with the sequence according to FIGS. 1a to 1e the load current I_{L} flows from the tapped transformer 9 to the current take-off 11, so that load current I_{L} and step voltage U_{St} in the transformer winding are in opposite phase. In particular, according to FIG. 1a the load current I_{L} initially flows via the path 41 with the closed switch 31, with which the voltage of the winding tap n is associated, namely the basic voltage U₀. Thus, the basic voltage U₀ is present as output voltage U of the tapped transformer 9. The paths 43 and 44 are interrupted, since the switches 33 and 34 thereof are opened so that no current flows here. The switch 32 of the path 42 is in fact closed, but here, as well, no or comparatively little current flows, since the resistance of the path 41 without a switch-over resistance is smaller than that of the path 42 with the switch-over resistance R₁ and the electric current preferentially follows the route of the least electrical resistance.

In the case of FIG. 1b the load current I_{L} flows via the path 42, thus via the switch-over resistance R₁ and the closed switch 32, since the paths or switching paths 41, 43, 44 are interrupted by the opened switches 31, 33, 34. The voltage drop at the switch-over resistance R₁ causes decay of the output voltage U of the tapped transformer 9 below the basic voltage U₀ to, in total, U₀−I_{L}*R₁.

In the case of FIG. 1c the load current I_{L} flows via the resistance paths 42 and 43 and thus via the switch-over resistances R₁ and R₂. The output voltage U of the tapped transformer 9 increases to, in total, U₀−½I_{L}*R₁+½U_{St}, assuming the resistances R₁ and R₂ are of the same height; otherwise a proportional relationship different from to arises.

Subsequently, according to FIG. 1d the switch 32 is opened with the consequence that the load current I_{L} flows only via the resistance path 43 and thus by way of the switch-over resistance R₂. The output voltage U of the tapped transformer 9 thus increases again to, in total, U₀+U_{St}−I_{L}*R₂.

Finally, according to FIG. 1e the switch 34 is closed so that the load current I_{L} flows only via the current path 44 and thus by way of the closed switch 34. The switch 33 of the resistance path 43 can again remain closed as in the case of the previous voltage step according to FIG. 1c, but no or only a little current flows via the resistance path 43, since the resistance of the current path 44 without a switch-over resistance is less than in the case of the resistance path 43 with the switch-over resistance R₂ and the electrical current preferentially follows the route of the least electrical resistance. The output voltage U of the tapped transformer 9 finally increases again to, in total, U₀+U_{St}. The switching over from the winding tap n of the tapped transformer 9 to the winding tap n+1 of the tapped transformer 9 is now concluded, since the load current I_{L} now flows from the winding tap n+1 via the current path 44 to the current take-off 11.

FIG. 1f shows a diagram of all five previously described voltage steps of the output voltage U of the tapped transformer 9 that in accordance with FIGS. 1a-e arise during switching over from the winding tap n of the tapped transformer 9 to the winding tap n+1 of the tapped transformer 9 when the load current I_{L} flows from the tapped transformer 9 to the current take-off 11. In this case, when a voltage step is switched on the voltage drop at the switch-over resistance R₁ initially causes a drop of the output voltage U (from FIG. 1a to FIG. 1b) before the output voltage U is successively increased by voltage drops at the resistances R₁ and R₂ (FIG. 1b to FIG. 1e). As a result, a voltage interval A having a width greater than the step voltage U_{St} arises for the voltage fluctuation of the output voltage U. This means that the flicker level occasioned at the load changeover switch 1 of the prior art is too large and therefore not optimal.

As indicated by the upper arrowhead of the arrow 3, in the case of a load changeover from the winding tap n+1 to n by the on-load tap changer 1 according to the prior art the switching sequence runs through in reverse direction. For clarification, it may be additionally noted that in general always only one voltage step of the transformer 9 participates in the load changeover, namely that between U₀ and U₀+U_{St}. The other voltage levels of the output voltage U of the tapped transformer 9 arise due to voltage drops at the resistances R₁ and R₂.

FIGS. 2e to 2a show a switching sequence for the on-load tap changer 1 according to FIGS. 1a to 1e from the prior art, wherein the load current I_{L} now flows in the reverse direction from the current take-off 11 to the winding tap n+1 and thus the load current I_{L} and the step voltage U_{St} in the transformer winding are in phase. The reversal of the flow direction of the load current I_{L} with respect to the current take-off 11 can be effected not only by a reversal of the load current I_{L}, but also by reversal of the regulating winding by a preselector (not illustrated). The reference numeral 9 illustrates a part of the tapped transformer and, in particular, two taps n, n+1 of the regulating winding. Analogously to FIG. 1, the sequence 2a to 2e illustrates the switching on of a part winding from n to n+1 and the sequence 2e to 2a illustrates the switching back of a part winding from n+1 to n.

By comparison with FIGS. 1a-e, for FIGS. 2a-e a regionally different plot of the output voltage (see FIG. 2f) arises, as briefly explained in the following, through successive connection or actuation of the switches 31, 32, 33, 34. In that case, the switches 31, 32, 33, 34 in FIGS. 2a-e are closed or opened as in the respectively corresponding FIGS. 1a-e.

In FIG. 2e, the output voltage U of the tapped transformer 9 is, entirely analogously to FIG. 1e, U₀+U_{St}. After closing or opening of the switches 31, 32, 33, 34 the output voltage U of the tapped transformer in FIG. 2d is U₀+U_{St}+I_{L}*R₂, in FIG. 2c U₀+½I_{L}*R₁+½U_{St}, in FIG. 2b U₀+I_{L}*R₁ and in FIG. 2a, entirely analogously to FIG. 1a, U₀. FIG. 2f shows a diagram of all five previously described voltage steps of the output voltage U that arise in accordance with FIGS. 2e-a when the load current I_{L} flows from the current take-off 11 to the tapped transformer 9. Opening of the switch 34 initially produces a voltage drop at the switch-over resistance R₂ and thus initially a rise of the output voltage U of the tapped transformer 9 (from FIG. 2e to FIG. 2d). Thereafter, the output voltage U is successively reduced by further, corresponding connection or actuation of the switches 31, 32, 33 (FIG. 2d to FIG. 2a). As in the case of FIG. 1f, in the case of FIG. 2f also the voltage interval A of the voltage fluctuation of the output voltage U is wider than the step voltage U_{St} between the winding taps n, n+1. The flicker level caused is, with the on-load tap changer 1 of the prior art according to FIG. 1a to FIG. 2f, thus not optimally independent of the direction of the load current I_{L}.

FIGS. 3a to 6f show a switching sequence and the plots of the output voltage U of the tapped transformer 9 for a different on-load tap changer 1 according to the prior art with only one switch-over resistance R. The load current I_{L} and the step voltage U_{St} in the transformer winding are opposite in phase in the case of FIGS. 3 and 4 and in-phase in the case of FIGS. 5 and 6. FIGS. 3 and 5 illustrate the switching on of a winding tap from n to n+1 and FIGS. 4 and 5 illustrate the switching back of the winding part from n+1 to n.

The illustrated on-load tap changer 1 comprises a selector 7 and a load changeover switch 5, the load changeover of that takes place in five steps. The load changeover switch 5 comprises two resistance-free switching paths or current paths 41, 44 each with a respective switch 31, 34 as well as two switching paths or resistance paths 42, 43 with a common switch-over resistance R and a respective separate switch 32 or 33.

The on-load tap changer 1 additionally comprises a device (not illustrated) that ensures that regardless of the switching direction, from the winding tap n to the winding tap n+1 or conversely, the switch 31 or 34 in the resistance-free path 41 or 44 in FIGS. 3 to 6 always opens and closes before the switch 32 or 33 in the parallel resistance path 42 or 43. As a result four cases A to D with different plots of the output voltage U, as described in the following, arise.

FIGS. 3a to 3e (case A) show a switching sequence for the other on-load tap changer 1, wherein the load current I_{L} flows in the direction of the load diverter 11 so that the load current I_{L} and the step voltage U_{St} in the transformer winding are opposite in phase. Switching from the winding tap n to n+1 takes place. Through the successive connection or actuation of the switches 31, 32, 33, 34 there arises, as output voltage U of the tapped transformer 9, in total U₀ in the case of FIG. 3a, U₀−I_{L}*R in the case of FIG. 3b, and U₀+U_{St} in the case of FIGS. 3c-e, also illustrated in the diagram according to FIG. 3f. In the case of the load current I_{L} in the direction of the load diverter 11, through opening of the switch 31 (FIG. 3a to FIG. 3b) a transient decrease in the output voltage U to U₀−I_{L}*R arises due to the voltage drop of the load current I_{L} at the switch-over resistance R. Resulting therefore during the load changeover is a voltage interval A having a width greater than the step voltage U_{St} so that the flicker level caused is not optimal.

FIGS. 4e to 4a (case B) show a switching sequence for another on-load tap changer 1 according to FIGS. 3a-e, wherein the load current I_{L} similarly flows in the direction of the load diverter 11, thus the load current I_{L} and the step voltage U_{St} in the transformer winding are in opposite phase, but switched down from the winding tap n+1 to n. As a consequence of the successive connection or actuation of the switches 31, 32, 33, 34, there arises as output voltage U at the current take-off 11 in total U₀+U_{St} in FIG. 4e, U₀+U_{St}−I_{L}*R in FIG. 4d and U₀ in FIGS. 4c-a, also illustrated in the diagram according to FIG. 4f. The voltage interval A of the voltage fluctuation of the output voltage U during the load changeover is equal to the step voltage U_{St}, so that the flicker level that is caused is optimal in this case.

FIGS. 5a to 5e (case C) show a switching sequence for the other on-load tap changer 1 according to FIGS. 3a to 3e, wherein the load current I_{L} flows in reverse direction against the load diverter 11 so that the load current I_{L} and the step voltage U_{St} in the transformer winding are in phase. Switching on takes place from the winding tap n to n+1. By virtue of the successive actuation of the switches 31, 32, 33, 34 there results, as output voltage U, in total U₀ in the case of FIG. 5a, U₀+I_{L}*R in the case of FIG. 5b and U₀+U_{St} in the case of FIGS. 5c-e, also illustrated in the diagram according to FIG. 5f. In this case the voltage interval A of the voltage fluctuation of the output voltage U during the load changeover process is similarly equal to the step voltage U_{St} so that the flicker level that is caused is, as in the case of FIGS. 4e-a, optimal.

FIGS. 6e to 6a (case D) show a switching sequence for the switching sequence for the other on-load tap changer 1 according to FIGS. 3a to 3e, wherein the load current I_{L} flows in reverse direction against the load diverter 11, thus the load current I_{L} and the step voltage U_{St} in the transformer winding are in phase, and is switched down from the winding tap n+1 to n. Through the successive connection or actuation of the switches 31, 32, 33, 34 there thus results as output voltage U of the tapped transformer 9 in total U₀+U_{St} in FIG. 6e, U₀+U_{St}+I_{L}*R in FIG. 6d, and U₀ in FIGS. 6c-e, also illustrated in the diagram according to FIG. 6f. Through actuation (closing) of the switch 31 at FIG. 6d there is, according to FIG. 6c, a circular current I_{C} via the switch-over resistance R and thereby a transient strong decay of the output voltage U from U₀+U_{St}+I_{L}*R to U₀. A voltage interval A, the width of that is greater than the step voltage U_{St} so that the flicker level produced is not optimal, thereby arises for the voltage fluctuation during the load changeover.

FIG. 7 shows a form of embodiment of the on-load tap changer 1 according to the invention that comprises a separate load changeover switch 5 and a selector 7. According to the invention the load changeover switch 5 comprises, beyond the already previously explicitly described usual elements (paths 41, 42, 43, 44, current take-off 11, switches 31, 32, 33, 34), additionally a measuring device for measuring an actual value j_{Real} of a phase angle j between the load current I_{L} and the voltage of the tapped transformer 9 from the preselected winding tap to the diverter 11 of the tapped transformer 9. In the illustrated form of embodiment according to FIG. 7 the measuring device comprises two voltage sensors 131, 132 and one current sensor 15. The voltage between the winding tap n and the current take-off 11 can be measured by the first voltage sensor 131. The voltage between the winding tap n+1 and the current take-off 11 can be measured by the second voltage sensor 132. The current in the current take-off 11 can be measured by the current sensor 15.

If the load current I_{L} flows, for example, via the tap n then the actual value of the phase angle j between the load current I_{L} and the voltage of the tapped transformer 9 from the preselected winding tap to the diverter 11 can, as is known, be determined from the voltage measured by the second voltage sensor 132 and the current measured by the current sensor 15. If, thereagainst, the load current I_{L} flows via the tap n+1, then the actual value Real of the phase angle j can, as is known, be determined from the voltage measured by the first voltage sensor 131 and current measured by the current sensor 15.

Prior to switching over from the winding tap n to the winding tap n+1 the first voltage sensor 131 does not measure any voltage, since it is short-circuited by the closed switch 31, and the second voltage sensor 132 measures the step voltage U_{St}.

The load changeover switch 5 according to the invention additionally comprises an adjuster (not illustrated), by which the paths 41, 42, 43, 44 or the switches 31, 32, 33, 34 thereof are variably settable or connectable in dependence on the measured actual value j_{Real} of the phase angle j and a preset limit value j_{Limit} of the phase angle j in such a manner that during all steps of the load changeover process the output voltage U of the transformer 9 always lies within a voltage interval A. In that case, the voltage interval is defined by the basic voltage U₀ and the basic voltage U₀ multiplied by the step voltage U_{St}.

FIG. 8 shows another form of embodiment of the load changeover switch 5 according to the invention of the on-load tap changer 1 in accordance with the invention, in which a different measuring device with one voltage sensor 13 and two current sensors 151, 152 is provided. The step voltage U_{St} between the connected winding tap n and the preselected winding tap n+1 can be measured by the voltage sensor 13. The current from the connected winding tap n to the current take-off 11 can be measured by the first current sensor 151. The current from the preselected winding tap n+1 to the current take-off 11 can be measured by the second current sensor 152.

If the load current I_{L} flows via the tap n, then the actual value j_{Real} of the phase angle j between the load current I_{L} and the voltage U of the tapped transformer 9 from the preselected winding tap to the current diverter 11 can, as is known, be determined from the voltage measured by the voltage sensor 13 and current measured by the first current sensor 151. If, thereagainst, the load current I_{L} flows via the tap n+1, then the actual value j_{Real} of the phase angle j can, as is known, be determined from the voltage measured by the voltage sensor 13 and current measured by the second current sensor 152.

Prior to switching over from the winding tap n to the winding tap n+1 the first current sensor 151 measures the load current I_{L} and the second current sensor 152 does not measure any current. After the switching-over process the first current sensor 151 does not measure any current and the second current sensor 152 measures the load current I_{L}.

Apart from the sensors 13, 151, 152 the construction and mode of function of the load changeover switch 5 is as per FIG. 7. FIG. 9 shows the on-load tap changer 1 according to the invention with the load changeover switch 5 according to the invention in accordance with FIG. 7, wherein the two switches 31 and 34 in the current paths 41 and 44 respectively as well as the two switches 32, 33 in the resistance paths 42 and 43 respectively are each replaced by a changeover switch 35 or 36 in series with an off-switch 37 or 38. The changeover switch 35 switches over between the paths 41 and 44. The changeover switch 36 switches over between the paths 42 and 43. The resistance paths 42, 43 have a common switch-over resistance R. In that case, the switches 35-38 of the paths 41 to 44 are connected in such a manner, thus opened or closed, that the output voltage U of the tapped transformer 9 is the basic voltage U₀.

FIG. 10 shows the on-load tap changer 1 according to the invention with the load changeover switch 5 according to the invention in accordance with FIG. 8 with the different measuring device. The changeover switches 35, 36 and the off-switches 37, 38 are otherwise arranged as per FIG. 9. FIG. 10 shows how, with this different switching mode with changeover switches and off-switches, the measuring device 13, 151, 152 is arranged.

According to FIGS. 11 to 14 different—in particular reduced in flicker—switching sequences arise over the entire changeover process from the connected winding tap n to the preselected winding tap n+1 (or vice versa) by comparison with FIGS. 3-6, as described in detail at a later point.

FIGS. 11 to 14 each show a switching sequence or a diagram of the voltage steps of the output voltage U for the forms of embodiment of the on-load tap changer 1 according to the invention in accordance with FIGS. 7 to 10 with a switch-over resistance R, as described in the following. In the case of FIGS. 11 and 12, the load current I_{L} and the step voltage U_{St} in the transformer winding are opposite in phase and in the case of FIGS. 13 and 14 they are in-phase. FIGS. 11 and 13 illustrate the switching on of a winding part (from n to n+1) and FIGS. 12 and 14 show the switching back of a winding part (from n+1 to n).

In FIGS. 11a to 11e the paths 41 to 44 are connected for the case that the measured actual value j_{Real} of the phase angle j is less than the amount of the preset limit value j_{Limit} of the phase angle j (case 1).

By comparison with FIGS. 3a-e the switching sequence is different, in particular so that a minimal flicker arises, thus the output voltage U does not depart from the voltage interval A between the winding taps n, n+1 (see FIG. 11f). For that purpose the switches 31 to 34 are so connected that the output voltage U in FIGS. 11a-c is U₀, in FIG. 11d is U₀+U_{St}−I_{L}*R and in FIG. 11e is U₀+U_{St}. FIG. 11f shows a diagram of the voltage steps of the output voltage U for the on-load tap changer 1 according to the invention in accordance with FIGS. 11a-e.

It is generally applicable to the invention that if the phase position of the measured voltage of the tapped transformer 9 from the preselected winding tap to the current diverter 11 corresponds with the measured current (load current I_{L}) or if the measured actual value j_{Real} of the phase angle j is smaller in terms of amount than the preset limit value j_{Limit} of the phase angle j then the switching sequence is to be selected so that initially the switch in the resistance path with the switch-over resistance R closes on the switching-on side. In the case of the form of embodiment and conditions according to FIG. 11 the switch 33 of the resistance path 43 thus initially closes in the case of the winding tap n+1 (see, in particular, the change in the switching sequence from FIG. 11b to FIG. 11c). Only subsequently does the switch of the resistance-free current path on the switching-off side in general open. In the form of embodiment and conditions according to FIG. 11 the switch 31 of the current path 41 thus opens only later in the case of the winding tap n (see, in particular, the change in switching sequence from 11c to FIG. 11d).

The circuits of FIG. 3a and FIG. 11a are, in particular, identical. Equally, the circuits of FIG. 3e and FIG. 11e are identical. However, the circuits of FIG. 3b and FIG. 11b are different. Equally the circuits of FIG. 3c and FIG. 11c are different, as are those of FIG. 3d and FIG. 11d. The differences are based on the different sequence in the actuation of the switches, as already described above.

In FIGS. 12e to 12a the paths 41 to 44 are connected for the case that the measured actual value j_{Real} of the phase angle j is greater than the amount of the preset limit value j_{Limit} of the phase angle j (case 2).

By comparison with FIGS. 4e-a the switching sequence is identical, because—since in FIGS. 4e-a a minimal flicker already results, thus the output voltage U always lies within the voltage interval A between the winding taps n, n+1 (see FIG. 12f)—in the case of the load changeover switch 5 according to the invention or on-load tap changer 1 according to the invention no other switching sequence and no other arrangement of the switches 31-34 and the paths 41-44 are necessary by comparison with the prior art.

In general, it also applies to the invention that if the phase position of the measured output step voltage U does not correspond with that of the measured current or if the measured actual value j_{Real} of the phase angle j in terms of amount is greater than the preset limit value j_{Limit} of the phase angle j then the switching sequence is to be selected so that initially the switch in the resistance-free current path on the switching-on side closes. In the form of embodiment and conditions according to FIG. 12 thus initially the switch 31 of the current path 41 closes in the case of the winding tap n (see, in particular, the change in the switching sequence from FIG. 12d to FIG. 12c). Only subsequently does the switch in the resistance path with the switch-over resistance R on the switching-off side generally open. In the form of embodiment according to FIG. 12 and conditions the switch 33 of the resistance path 43 thus opens only later in the case of the winding tap n+1 (see, in particular, the change in the switching sequence from FIG. 12c to FIG. 12b).

In FIGS. 13a to 13e the paths 41 to 44 are connected for the case that the measured actual value j_{Real} of the phase angle j is greater than the amount of the preset limit value j_{Limit} of the phase angle j (case 2).

By comparison with FIGS. 5a-e the switching sequence is identical, because—since a minimal flicker already arises with FIGS. 5a-e, thus the output voltage U always lies within the voltage interval A between the winding taps n, n+1 (see FIG. 13f)—in the case of the load changeover switch according to the invention or on-load tap changer 1 according to the invention no other switching sequence is necessary by comparison with the prior art.

Entirely analogously to FIG. 12 it generally also applies to the invention in the case of FIG. 13 that if the phase position of the measured output step voltage U does not correspond with the measured current or if the measured actual value j_{Real} of the phase angle j is greater in terms of amount than the preset limit value J_{Limit} of the phase angle j then the switching sequence is to be selected so that initially the switch in the resistance-free path on the side switching on closes. In the form of embodiment and conditions according to FIG. 13 the switch 34 of the current path 44 thus initially closes in the case of the winding tap n+1 (see, in particular, the change in switching sequence from FIG. 13b to FIG. 13c). Only subsequently does the switch in the resistance path with the switch-over resistance R on the switching-off side in general open. In the form of embodiment and conditions according to FIG. 13 the switch 32 of the resistance path 42 thus opens only later in the case of the winding tap n (see, in particular, the change in the switching sequence from FIG. 13c to FIG. 13d).

In FIGS. 14e to 14a the paths 41 to 44 are connected for the case of the measured actual value j_{Real} of the phase angle j being less than the amount of the preset limit value j_{Limit} of the phase angle j (case 1).

By comparison with FIGS. 6a-e the switching sequence is different, in particular so that a minimal flicker results, thus the output voltage U always lies within the voltage interval A between the winding taps n, n+1 (see FIG. 14f). For that purpose the switches 31 to 34 are so connected that the output voltage U in FIGS. 14e-c is U₀+U_{St}, in FIG. 11b is U₀+I_{L}*R and in FIG. 11a is U₀. FIG. 14f shows a diagram of the voltage steps of the output voltage U for the on-load tap changer according to the invention in accordance with FIGS. 14e-a.

Entirely analogously to FIG. 11 it also generally applies to the invention in the case of FIG. 14 that if the phase position of the measured step voltage U_{St} corresponds with that of the measured current or if the measured actual value j_{Real} of the phase angle j in terms of amount is less than the preset limit value j_{Limit} of the phase angle j then the switching sequence is to be selected so that initially the switch in the resistance path on the switching-on side closes. In the form of embodiment and conditions according to FIG. 14 the switch 32 in the resistance path 42 thus initially closes in the case of the winding tap n (see, in particular, the change in the switching sequence from FIG. 14d to FIG. 14c). Only subsequently does the switch of the resistance-free current path on the switching-off side in general open. In the form of embodiment and the conditions according to FIG. 14 the switch 34 of the current path 44 thus opens only later in the case of the winding tap n+1 (see, in particular, the change in the switching sequence from FIG. 14c to FIG. 14b).

FIGS. 15a to 15c show circuits for a different form of embodiment of the on-load tap changer 1 according to the invention with respectively combined load changeover switch 5 and selector 7. In that case, the selector 7 comprises the ends of the paths 411, 421 of the load changeover switch 5 in the direction of the winding taps n, n+1. The adjuster 2 in the form of embodiment illustrated here comprises a double reverser according to the prior art, such as, for example, from DE 102007023124 B3. However, this arrangement is by way of example and other arrangements are also conceivable, so that the output voltage U gives the amount U₀ and, in particular, the output voltage U always lies within the voltage interval A between the winding taps n, n+1 so as to keep the flicker minimal.

The phase angle j between the load current I_{L} and the voltage of the tapped transformer 9 from the preselected winding tap to the diverter 11 is measured by the measuring device 131, 132, 15 as already described in FIG. 7. Depending on the measured phase angle, according to the invention use is made either of the end setting according to FIG. 15a or the end setting according to FIG. 15c for a circuit. If the measured actual value j_{Real} in terms of amount is less than the limit value j_{Limit} then a first end setting of the adjuster 2 according to FIG. 15a is used or is switched over to. Otherwise, switching over is to a second end setting of the adjuster 2 according to FIG. 15c. In that case, FIG. 15b represents an intermediate setting during the respective switching-over process, in which all paths are short-circuited and the load current I_{L} flows via the path 415 to the load diverter 11.

In the end setting according to FIG. 15a the switch 38 in the resistance path 424, 425 on the switching-on side initially closes in the case of switching of the winding tap n to n+1. Only subsequently does the switch 37 of the resistance-free current path 414, 415 on the switching-off side open (case 1). The converse is the case for switching the winding tap n+1 to n (case 2).

In the end setting according to FIG. 15c the behavior is exactly the reverse of FIG. 15a. Alternatively, the sensors 13, 151, 152 described in FIG. 8 can also be used as measuring device. It may be noted that merely for reasons of clarity the measuring device 131, 132, 15 is illustrated only in FIG. 15a (not in FIGS. 15b-c).

The actuation in accordance with the invention of the adjuster 2 in dependence on the comparison of measured actual value j_{Real} and limit value j_{Limit} ensures that analogously to FIGS. 7-14, also in the case of the form of embodiment of the on-load tap changer 1 or of the load changeover switch 5 according to FIGS. 15a-c the output voltage U always lies within the voltage interval A between the taps n, n+1, the flicker level thus being minimal. The output voltage U at the start of the switching can be, as in FIGS. 1 to 14, not only U₀, but also U_{St}.

FIG. 16 shows a schematic flow chart of the method according to the invention for switching over a load changeover switch 5 of an on-load tap changer 1 from a connected winding tap n of a tapped transformer 9 to a preselected winding tap n+1 of the tapped transformer 9. A limit value j_{Limit} of a phase angle j between the load current I_{L} and the voltage U from the preselected winding tap to the current diverter 11 is preset. According to step S2, an actual value j_{Real} of the phase angle j is measured usually at regular intervals in time, in particular prior to each switching-over process of the load changeover switch 5 (step S1). If the measured actual value of the phase angle in terms of amount is less than the preset limit value of the phase angle (step S3, adjuster 2 in position 1), initially the switch in the resistance path on the switching-on side closes. Only subsequently does the switch of the resistance-free current path on the switching-off side open. If, thereagainst, the measured actual value of the phase angle is greater in terms of amount than the preset limit value of the phase angle (step S4, adjuster 2 in position 2), the switch of the resistance-free current path on the switching-on side initially closes. Only subsequently does the switch in the resistance path on the switching-off side close. After adjustment has been carried out, the load changeover process is performed (step S5).

The invention was described with reference to preferred forms of embodiment. However, it will be obvious to any expert that modifications and changes can be undertaken without in that case departing from the scope of protection of the appended claims. Thus, for example, the adjuster 2 can be adjusted, instead of by rotation, also by pushing or by another form of movement and the principle of the invention functions regardless of the number of voltage steps of the on-load tap changer 1. The exemplifying embodiments explained in the preceding serve merely for description of the claimed teaching, but do not restrict this to the exemplifying embodiments.

### REFERENCE NUMERAL LIST

1 on-load tap changer

2 adjuster

3, 4 switching sequence

5 load changeover switch

7 (fine) selector

9 tapped transformer

11 current take-off or load diverter

13, 131, 132 voltage sensor

15, 151, 152 current sensor

21 first adjusting element (cam disc)

22 second adjusting element (cam disc)

31-38 switch

41-44, 411-425 path

w rotational movement

n, n+1 winding tap

A voltage interval

R, R₁, R₂ switch-over resistance

I_{C} circular current

I_{L} load current

U_{St} step voltage

U output voltage of the tapped transformer

1. A load changeover switch for an on-load tap changer for switching over from a connected winding tap to a preselected winding tap of a tapped transformer, the switch comprising
at least one resistance-free current path,
at least one resistance path with at least one respective switch over resistance
a current take-off for conducting a load current flowing between the tapped transformer and the current take-off, a step voltage being present between the winding taps,
measuring means for measuring an actual value of a phase angle between the load current and a voltage of the tapped transformer from the preselected winding tap to the current take-off, and
adjusting means, by which the time sequence of the connection of the paths of the load changeover switch is variably adjustable in dependence on the measured actual value of the phase angle and a predetermined limit value of the phase angle in such a manner that during a load changeover the voltage always lies within a voltage interval between the connected winding tap and the preselected winding tap.

2. The load changeover switch according to claim 1, wherein at least one switch of the paths is connectable by the adjusting means.

3. The load changeover switch according to claim 1, wherein the predetermined limit value of the phase angle is 90°.

4. The load changeover switch according to claim 1, wherein the measuring means comprises two voltage sensors and a current sensor, wherein the voltage between the connected winding tap and the current take-off can be measured by a first voltage sensor, the voltage between the preselected winding tap and the current take off can be measured by a second voltage sensor and the current in the current take-off can be measured by the current sensor.

5. The Load changeover switch according to claim 1, wherein the measuring means comprises a voltage sensor and two current sensors, wherein the voltage between the connected winding tap and the preselected winding tap can be measured by the voltage sensor, the current from the connected winding tap to the current take-off can be measured by a first current sensor and the current from the preselected winding tap to the current take off can be measured by a second current sensor.

6. The load changeover switch according to claim 1, wherein the resistance paths comprise precisely one common switch-over resistance and/or the resistance paths each comprise a respective switch-over resistance upstream of the combining of the resistance paths in the direction of the current take-off.

7. The on-load tap changer with at least one load changeover switch according to claim 1, further comprising:
a selector for selecting a respective winding tap of the tapped transformer.

8. A method of switching over a load changeover switch of an on-load tap changer from a connected winding tap of a tapped transformer to a preselected winding tap of the tapped transformer, the method comprising the following steps:
presetting a limit value of a phase angle between a load current that flows between the tapped transformer and a current take-off of the load changeover switch, and a voltage from the preselected winding tap to the current take-off;
measuring an actual value of the phase angle; and
connecting at least two switches of paths in a predetermined time sequence in dependence on whether the actual value of the phase angle is greater or smaller than the amount of the limit value of the phase angle in such a manner that during a load changeover process the voltage of the tapped transformer always lies within a voltage interval between the connected winding tap and the preselected winding tap.

9. The method according to claim 8, further comprising the following steps:
if the measured actual value of the phase angle is less in terms of amount than the preset limit value of the phase angle then
initially the switch of a resistance path on the side switching on closes and subsequently the switch of a resistance-free current path on the side switching off opens; and if the measured actual value of the phase angle is greater in terms of amount than the preset limit value of the phase angle then
initially the switch 31, 34, 37) of the resistance-free current path on the side switching on closes and subsequently the switch of the resistance path on the side switching off opens.
